(19) United States
(12) Patent Application Publication
(10) Pub. No.: US 2025/0293900 A1
(43) Pub. Date: Sep. 18, 2025

(54) TRANSCEIVER AND CONTROL SYSTEM

(71) Applicant: DENSO CORPORATION, Kariya-city (JP)

(72) Inventor: Yasuhiro KOTANI, Kariya-city (JP)

(21) Appl. No.: 19/000,968

(22) Filed: Dec. 24, 2024

(30) Foreign Application Priority Data
Mar. 14, 2024 (JP) 2024-040057

(51) Int. Cl. H04L 12/40

(52) U.S. Cl. CPC H04L 12/40039; H04L 2012/40215; H04L 2012/40273

(57) ABSTRACT

A transceiver is mounted in an electronic control unit, and includes: a detection unit configured to detect control data; and a setting unit configured to enable and disable a sleep function and a wake-up function of the transceiver based on whether control data has been detected. The electronic control unit operates in any one of the plurality of states. When a state in which no communication is performed continues after transition to a first state, the electronic control unit transitions to a second state or a third state. In the third state, a process is executed to stop a part of a function operating in the first state. In the second state, in a case where communication occurs between the transceiver and the communication device by the sleep function or the wake-up function, the second state transitions to the first state.

### CROSS REFERENCE TO RELATED APPLICATION

The present application claims the benefit of priority from Japanese Patent Application No. 2024-040057 filed on Mar. 14, 2024. The entire disclosure of the above application is incorporated herein by reference.

### TECHNICAL FIELD

The present disclosure relates to a transceiver.

### BACKGROUND

Vehicles are equipped with a large number of ECUs (Electronic Control Units) to control in-vehicle devices. By connecting these ECUs to communication buses, a network system in which the ECUs serve as nodes is constructed. In such a network system, when no packet has flowed in the network for a certain period of time, an operation mode of the ECUs transitions from a normal mode to a power saving mode. In the normal mode, various functions are operational. In the power saving mode, some functional operations in the normal mode are stopped, which reduces power consumption. Power consumption is reduced by disabling a part of functions.

In a comparative example, a network system enables low power consumption by forming a partial network and by activating nodes that form the network or having the nodes become dormant as needed. The partial network is a power supply control method based on the communication control of the CAN (Registered Trademark, Controller Area Network) protocol standard defined in ISO 11898-6.

### SUMMARY

A transceiver is mounted in an electronic control unit, and includes: a detection unit configured to detect control data; and a setting unit configured to enable and disable a sleep function and a wake-up function of the transceiver based on whether control data has been detected. The electronic control unit operates in any one of the plurality of states. When a state in which no communication is performed continues after transition to a first state, the electronic control unit transitions to a second state or a third state. In the third state, a process is executed to stop a part of a function operating in the first state. In the second state, in a case where communication occurs between the transceiver and the communication device by the sleep function or the wake-up function, the second state transitions to the first state.

### BRIEF DESCRIPTION OF THE DRAWINGS

The above and other features and advantages of the present disclosure will become more apparent from the following detailed description made with reference to the accompanying drawings, in which like parts are designated by like reference numbers.

FIG. 1 is a block diagram showing a configuration of a control system.

FIG. 2 is a block diagram showing a configuration of a transceiver.

FIG. 3 is a flowchart showing a process for enabling and disabling a sleep function and a wake-up function in the transceiver of a first embodiment.

FIG. 4 is a state transition diagram showing operation modes of a controller.

FIG. 5 is a flowchart showing a process for enabling and disabling the sleep function and the wake-up function in the transceiver of a second embodiment.

### DETAILED DESCRIPTION

Each ECU includes a transceiver as a communication interface for communicating with other ECUs. The transceiver assumes that other ECUs on the network are in the power saving mode when a link connected to the ECUs breaks down, which is in a link-down state. The transceiver may transmit a wake-up request that requests the ECUs in the link-down state to enter the normal mode.

The transceiver may unintentionally transmit the wake-up request to an ECU that is ready to enter the power saving mode from the normal mode when the transceiver wrongly recognizes that the link is in the link-down state, for example, due to poor communication conditions in the network.

Therefore, when the ECU transitioning to the power saving mode receives the wake-up request before executing processing to partially stop operations in the normal mode, the execution of the processing may be unintentionally prevented.

One example of the present disclosure avoids unintentional prevention of mode transition of an electronic control unit to a mode in which a part of its functions are stopped, such as a power saving mode, the prevention being caused by a transceiver installed in the electronic control unit.

According to one example of the present disclosure, a transceiver is mounted in an electronic control unit for a vehicle and configured to perform communication with a communication device, and the transceiver includes: a detection unit; and the setting unit. The detection unit is configured to detect control data used at least for controlling a state transition of the electronic control unit, the control data being transmitted from the communication device through the communication. The setting unit is configured to enable and disable a sleep function and a wake-up function of the transceiver.

The state transition is a transition between a plurality of states including at least a first state, a second state, and a third state. The electronic control unit transitions between the plurality of states, and operates in any one of the plurality of states. When a state in which no communication is performed continues after transition to the first state, the electronic control unit transitions to the second state or the third state in sequence according to a continuation period of the state in which no communication is performed. In the third state, the electronic control unit executes a process to stop a part of a function operating in the first state. In the second state, when the communication occurs between the transceiver and the communication device by the sleep function or the wake-up function of the transceiver, the second state transitions to the first state.

The setting unit is configured to enable and disable the sleep function and the wake-up function based on whether the control data has been detected by the detection unit. According to such a configuration, in the second state during the transition from the first state to the third state, it is possible to prevent the transition to the first state based on the sleep function and wake-up function of the transceiver. Therefore, it is possible to prevent the electronic control unit from unintentionally preventing the transition to the third state due to the sleep function and wake-up function of the transceiver.

Hereinafter, exemplary embodiments of the present disclosure will be described with reference to the drawings.

### 1. First Embodiment

### 1-1. Configuration

### 1-1-1. Overall Configuration

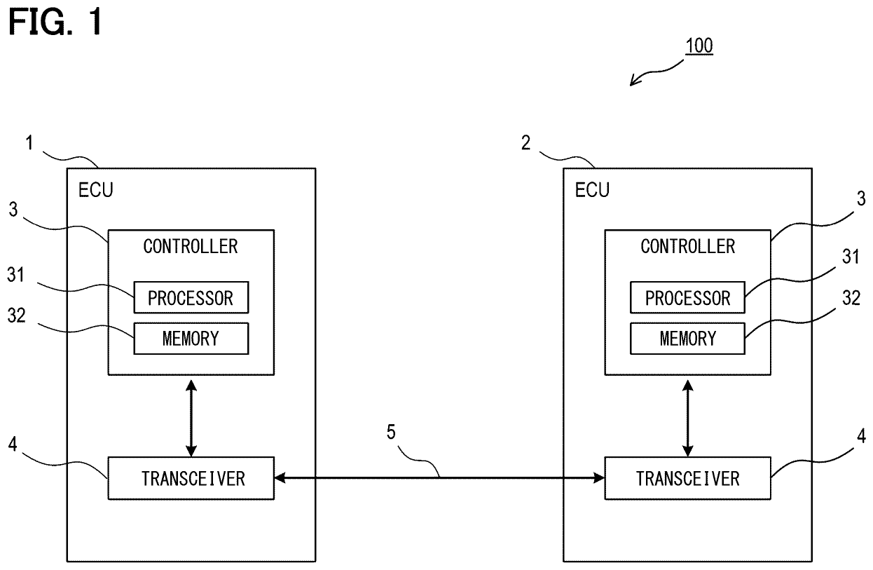

A control system 100 according to the present embodiment is shown in FIG. 1, and the control system 100 is mounted on a vehicle. The control system 100 includes a first ECU 1 and a second ECU 2. The first ECU 1 and the second ECU 2 are connected to the same in-vehicle network. The first ECU 1 and the second ECU 2 may be, for example, an ECU that processes information obtained from sensors such as cameras and radars for automated driving, an ECU that processes information to be output to a display device such as a vehicle display or a meter, or an ECU that communicates with an external terminal.

Each of the first ECU 1 and the second ECU 2 includes a controller 3 and at least one transceiver 4. The controller 3 is a microcontroller having a processor 31 and a memory 32. The processor 31 is configured to execute processing in accordance with a computer program recorded in the memory 32. The memory 32 may include, for example, a random access memory (RAM) and a flash memory. The RAM is used as a working area during the processor 31 executing processing. The flash memory is capable of holding computer programs.

The transceiver 4 is a communication interface configured to communicate with other transceivers 4 through the in-vehicle network. The transceiver 4 is configured to communicate with other transceivers 4 using a predetermined communication protocol. The communication mentioned here includes transmissions and receptions of various signals, data, and the like. Each transceiver 4 communicates with the other transceivers 4 on a one-to-one basis. The predetermined communication protocol may be, for example, an Ethernet protocol. The communication protocol is not limited to Ethernet, but may also be CAN (Controller Area Network) or FlexRay. The Ethernet is a registered trademark. The CAN is a registered trademark. The FlexRay is a registered trademark.

The first ECU 1 and the second ECU 2 are connected with one another through a link 5 serving as a transmission path in the in-vehicle network. The first ECU 1 is capable of communicating with the second ECU 2 through the transceiver 4 of the first ECU 1 and the link 5. The second ECU 2 is capable of communicating with the first ECU 1 via the transceiver 4 and the link 5 of the second ECU 2.

### 1-1-2. Transceiver Configuration

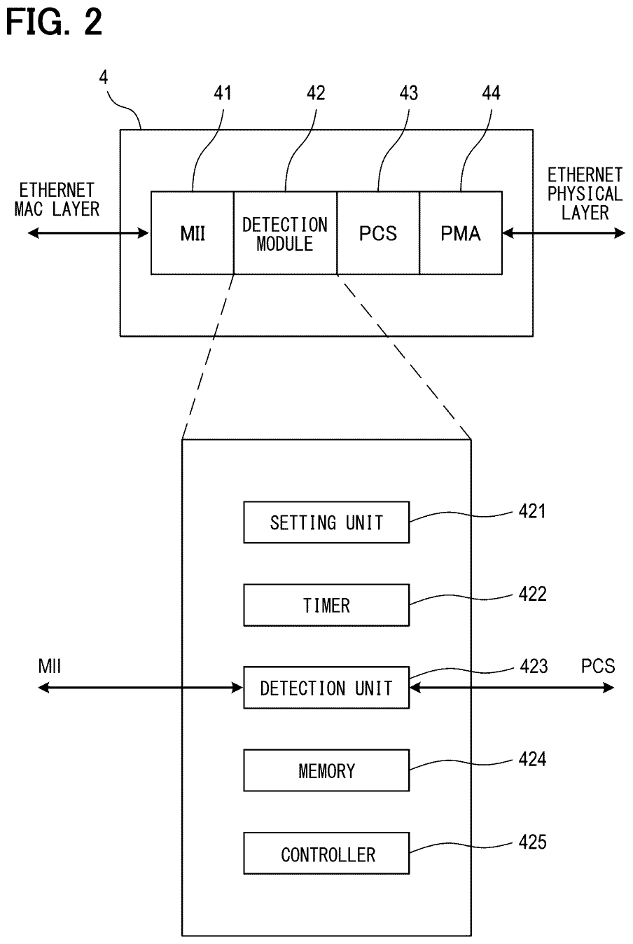

The transceiver 4 shown in FIG. 2 is an interface implemented in the physical layer of the OSI reference model. The transceiver 4 includes an MII 41, a detection module 42, a PCS 43, and a PMA 44.

The MII 41 is an abbreviation for Media Independent Interface. The MII 41 is an interface between the physical layer and the MAC layer (Media Access Control Layer). The MAC layer is a layer in the data link layer of the OSI reference model that is implemented based on IEEE 802.3, the Ethernet standard. The MII 41 is configured to pass transmission data transmitted by a communication device and passed from the MAC layer to the detection module 42 and pass received data passed from the detection module 42 to the MAC layer.

The detection module 42 is configured to detect control data that is at least used to control the state transition of the controllers 3 of the first ECU 1 and the second ECU 2. The detection module 42 is configured to pass the transmission data passed from the MII 41 to the PCS 43 and to pass the reception data passed from the PCS 43 to the MII 41. An example of control data is a NM (Network Management) frame. In the following description, an NM frame is used as the control data, but the control data is not limited to the NM frame and may be data other than an NM frame.

The NM frame is an Ethernet frame used in UdpNm (UDP Network Management) defined by AUTOSAR (AUTOmotive Open System ARCHitecture), a global development partnership in the automotive industry. The UDP is an abbreviation for User Datagram Protocol. The NM frame is primarily used for transitions regarding power saving modes of the ECU.

The detection module 42 includes a setting unit 421, a timer 422, a detection unit 423, a storage 424, and a controller 425. The setting unit 421 is configured to enable and disable a sleep function and a wake-up function of the transceiver 4 as described later.

The timer 422 is configured to reset and start counting when the NM frame is detected by the detection unit 423, and to count the elapsed time until a predetermined expiration time. The detection unit 423 is configured to determine whether the transmission data passed from the MII 41 and the reception data passed from the PCS 43 are NM frames. Whether the transmitted data and received data are NM frames is determined by checking at least one of a source port number or a destination port number in the UDP header of the transmitted data and received data. The source port number and destination port number corresponding to the NM frame are assigned in advance by a network administrator. When the source port number and destination port number of the transmitted data and received data correspond to the NM frame, the detection unit 423 determines that the transmitted data and received data are NM frames. When the source port number and destination port number of the transmitted data and received data do not correspond to the NM frame, the detection unit 423 determines that the transmitted data and received data are not NM frames.

The storage 424 is configured to store information of the NM frame. NM frame information is used by the detection unit 423 to determine whether the transmitted data and received data are the NM frames. The information of the NM frame includes at least one of a source port number or a destination port number for the NM frame. The information on the NM frame is set in advance in the storage 424 by the user.

The controller 425 executes processes for enabling and disabling the sleep function and wake-up function as described later. The PCS 43 is an abbreviation for Physical Coding Sublayer. The PCS 43 is configured to convert the transmission data passed from the detection module 42 into a transmission code and pass it to the PMA 44. In addition, the PCS 43 is configured to perform inverse conversion of the received code passed from the PMA 44 and pass it to the detection module 42 as received data. For example, in 100BASE-T1, the PCS 43 is configured to perform 4B/3B conversion, scrambling, and the like.

The PMA 44 is an abbreviation for Physical Media Attachment. The PMA 44 is configured to convert the transmission code received from the PCS 43 into a physical signal and pass it to a physical medium for transmission via MDI (Medium Dependent Interface). In addition, the PMA 44 is configured to convert signals received from the physical medium for transmission via the MDI from the physical signal to a received code for passing to the PCS 43.

### 1-2. Process

### 1-2-1. Operation States and Functions of Transceiver

The transceiver 4 operates in an operation state, which is one of multiple operation states. The multiple operation states include a normal state and a sleep state. The transceiver 4 switches between the normal state and the sleep state according to a predetermined protocol. One example of a specified protocol is a TC 10 (Technical Committee 10) defined by the non-profit organization OPEN Alliance (One-Pair Ether-Net Alliance). The transceiver 4 has the sleep function and the wake-up function.

The normal state is a state in which the transceiver 4 is capable of communicating with other transceivers 4. The sleep state is a state in which predetermined functions of the transceiver 4 available in the normal state are stopped. An example of the predetermined functions of the transceiver 4 is a function of transmitting various signals, data, and the like to other transceivers 4. The sleep state is a state in which power to restart the predetermined functions that has stopped is not supplied. Thus, the sleep state is a power saving state in which power consumption is reduced compared to the normal state. The transceiver 4 enters the sleep state when an ignition switch of the vehicle is turned on.

The sleep function is executed when requested by the controller 3 of the ECU to which the transceiver 4 belongs (hereinafter, referred to as a local ECU). By executing the sleep function, processing for stopping the predetermined functions of the transceiver 4 is performed. In other words, the sleep function is a function for the transceiver 4 to switch from the normal state to the sleep state upon the request from the controller 3.

The wake-up function is a function to perform processing to restart the predetermined functions of the transceiver 4 that have stopped by the sleep function. In other words, the wake-up function is a function for the transceiver 4 to enter the normal state from the sleep state.

The wake-up function is executed when the transceiver 4 receives a wake-up request. The wake-up request is a signal that requests the controller 3 to enter a network mode A101 described later.

The wake-up requests received by the transceiver 4 include a wake-up request transmitted from another ECU (hereinafter referred to as an adjacent ECU) that is an adjacent node in the in-vehicle network, and also includes a wake-up request transmitted from the controller 3 of the local ECU to the adjacent ECU. When the transceiver 4 receives the wake-up request from the adjacent ECU, the transceiver 4 notifies the controller 3 of the reception of the wake-up request. When the transceiver 4 receives the wake-up request transmitted from the controller 3 of the local ECU to the adjacent ECU, the transceiver 4 transmits the wake-up request to the adjacent ECU.

After completing the processing to restart the predetermined functions having stopped by the sleep function, the transceiver 4 enters the normal state from the sleep state.

### 1-2-2. Transceiver State Transition

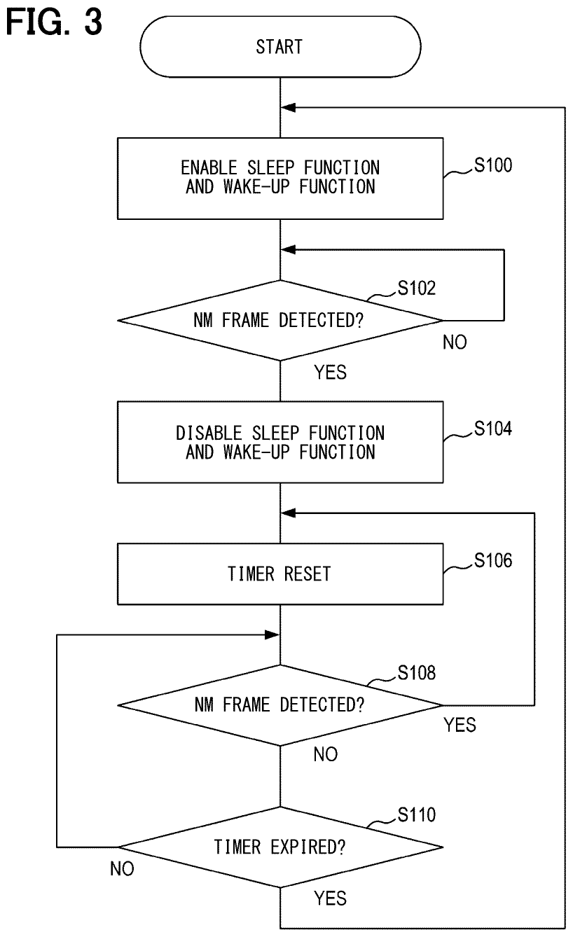

The process of enabling and disabling the sleep function and the wake-up function executed by the controller 425 of the detection module 42 will be described with reference to the flowchart of FIG. 3.

When the transceiver 4 transitions from the sleep state to the normal state, the controller 425 of the detection module 42 starts the process shown in FIG. 3. The controller 425 of the detection module 42 also starts the process shown in FIG. 3 when the transceiver 4 is reset and when the ignition switch of the vehicle is turned from off to on.

First, in S100, the controller 425 enables the sleep function and the wake-up function through the setting unit 421. Next, in S102, the controller 425 determines whether the detection unit 423 has detected the NM frame.

When the controller 425 determines that the NM frame has not been detected (S102: NO), the controller 425 repeats the determination as to whether the NM frame has been detected until it determines that the NM frame has been detected (S102).

When the controller 425 determines in S102 that the NM frame has been detected (S102: YES), the process proceeds to S104, where the controller 425 disables the sleep function and the wake-up function via the setting unit 421.

Next, in S106, the controller 425 resets and starts the count of the timer 422. Next, in S108, the controller 425 determines whether the detection unit 423 has detected the NM frame.

When the controller 425 determines in S108 that the NM frame has been detected (S108: YES), the process returns to S106. Thereby, the count of timer 422 is reset when the NM frame is detected.

On the other hand, when the controller 425 determines in S108 that the NM frame has not been detected (S108: NO), the process proceeds to S110, where it determined whether the timer 422 has reached a predetermined expiration time. The predetermined expiration time is the sum of a first predetermined period in a transition condition C2 described later, and a second predetermined period in a transition condition C4 described later. Alternatively, the predetermined expiration time is a third predetermined period in transition condition C4 described later. The predetermined expiration time may be equal to or greater than the sum of the first predetermined period and the second predetermined period.

When the controller 425 determines in S110 that the timer 422 has not reached the predetermined expiration time (S110: NO), the process returns to S108. Thereby, it is determined whether the NM frame has been detected again.

On the other hand, when the controller 425 determines in S110 that the timer 422 has reached the predetermined expiration time (S110: YES), the process proceeds to S100 and enables the sleep function and the wake-up function via the setting unit 421.

In this way, the transceiver 4 disables the sleep and wake-up functions when it detects the NM frame. When the transceiver 4 does not detect the NM frame for a predetermined period, it enables the sleep function and the wake-up function.

### 1-2-3. Operation Modes of Controller

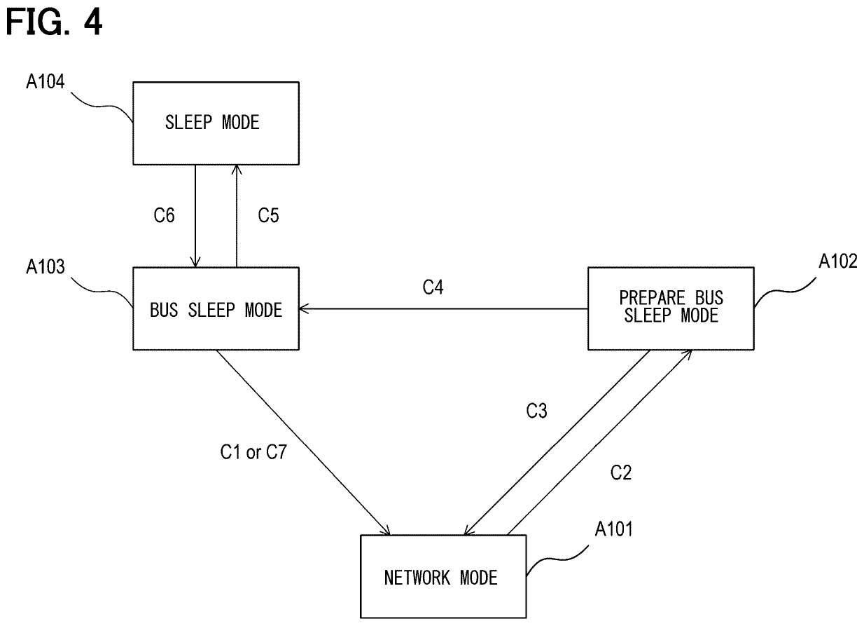

As shown in FIG. 4, the controller 3 has, as operation modes, the network mode A101, a prepared bus sleep mode A102, a bus sleep mode A103, and a sleep mode A104. The controller 3 transitions between the network mode A101, the prepared bus sleep mode A102, the bus sleep mode A103, and the sleep mode A104 in accordance with a predetermined protocol. One example of a predefined protocol is UdpNm, defined by AUTOSAR, a global development partnership of the automotive industry.

The network mode A101 is an operation mode in which the controller 3 communicates with the adjacent ECU through the transceiver 4. The controller 3 in the network mode A101 executes processes related to a communication with the adjacent ECU. Examples of the processing related to the communication include processing for generating various signals, data, and the like to be transmitted to the adjacent ECUs and transmitting them to the transceiver 4, and processing for acquiring various signals, data, and the like received by the transceiver 4 from the adjacent ECU. The network mode A101 is maintained until a first predetermined period has elapsed since the communication with the adjacent ECU has stopped. The first predetermined period is, for example, several milliseconds to several thousand milliseconds.

The prepared bus sleep mode A102 is an operation mode in which the ECU waits for a second predetermined period to elapse while no communication occurs between the local ECU and the adjacent ECU. The second predetermined period is, for example, about several milliseconds to several thousand milliseconds. The second predetermined period may be different from the first predetermined period in the network mode A101. The network mode A101 and the prepared bus sleep mode A102 are included in a normal mode in which various functions of the ECU operate.

The bus sleep mode A103 is an operation mode that performs processing required to stop some of the functions operating in the network mode A101 when entered from the prepared bus sleep mode A102. Examples of the functions to be stopped is generating various signals, data, and the like to be transmitted to the adjacent ECU and transmitting them to the transceiver 4. Examples of processing required to stop some of the functions include processing to disable the setting values of the controller 3 relating to transmission to the transceiver 4, and processing to stop operating clocks and the like used in the functions to be stopped.

In addition, the bus sleep mode A103 is an operation mode that executes the processing required to start operation in the network mode A101 when entered from the sleep mode A104 or when the power is supplied to the controller 3. Examples of the processing required to start operation in the network mode A101 include processing to enable the setting values of the controller 3 related to transmission to the transceiver 4, and processing to start the operating clocks used in creating various signals and data to be transmitted to the adjacent ECU and transmitting them to the transceiver 4. The processing executed by the controller 3 in the bus sleep mode A103 in this case includes restarting functions that have stopped after transition from the prepared bus sleep mode A102 to the bus sleep mode A103. Furthermore, the controller 3 transmits a wake-up request to the adjacent ECU via the transceiver 4. As a result, the controller 3 of the adjacent ECU enters the network mode A101 in which communication is available.

The sleep mode A104 is an operation mode in which some of the functions that operate in the network mode A101 are stopped. Alternatively, power is not supplied to the controller 3 in the sleep mode A104. The functions stopped in the sleep mode A104 are some of the functions for which required processing has been performed in the bus sleep mode A103. The sleep mode A104 is a power saving mode in which some functions are stopped to reduce power consumption compared to the normal mode.

### 1-2-4. Switch of Operation Mode of Controller

The switch of operation mode of the controller 3 will be described with reference to FIG. 4. When the ignition switch of the vehicle is turned on, the controller 3 enters the bus sleep mode A103 as an initial mode. Alternatively, the initial mode may be the sleep mode A104, and the controller 3 may enter the bus sleep mode A103 when the ignition switch of the vehicle is turned on.

In the bus sleep mode A103, the controller 3 executes processing required to start operation in the network mode A101. The process includes at least one of transmitting and receiving the NM frame. The example of the processing required to start operation in network mode A101 is described above. After this processing has been completed, the controller 3 determines that a transition condition C1 is satisfied and enters the network mode A101. The transition condition C1 is that the processing required to start operation in the network mode A101 has been completed.

Since the NM frame is transmitted or received until the transition condition C1 is satisfied, the sleep function and wake-up function of the transceiver 4 are disabled after the controller 3 transitions from the bus sleep mode A103 to the network mode A101.

When the controller 3 determines that the transition condition C2 is satisfied in the network mode A101, the controller 3 enters the prepared bus sleep mode A102. The transition condition C2 is that a first predetermined period (for example, several milliseconds to several thousand milliseconds) has elapsed without detecting communication with the adjacent ECU. In addition, the transition condition C2 may include that the ECU receives information or an instruction, which indicates a switch to the prepared bus sleep mode A102, from the adjacent ECU.

When the controller 3 determines that a transition condition C3 is satisfied in the prepared bus sleep mode A102, the controller 3 enters the network mode A101. The transition condition C3 is that communication with the adjacent ECU occurs. The communication with the adjacent ECU may be the transmission or reception of the NM frame.

When the controller 3 determines that the transition condition C4 is satisfied in the prepared bus sleep mode A102, the controller 3 enters the bus sleep mode A103. The transition condition C4 is a condition that a second predetermined time (for example, several milliseconds to several thousand milliseconds) has elapsed from the time of transition to the prepared bus sleep mode A102 while no communication with the adjacent ECU is occurring. The second predetermined period in the transition condition C4 may be different from the first predetermined period in the transition condition C2, or may not be provided. In other words, the second predetermined period may be 0 seconds.

In the transition condition C4, a third predetermined period may be used instead of the second predetermined period. The counting of the third predetermined period in the transition condition C4 starts at the time when the last communication occurs in the network mode A101. That is, the third predetermined period corresponds to the sum of the first predetermined period and the second predetermined period. The third predetermined period in the transition condition C4 is equal to or greater than the first predetermined period in the transition condition C2.

When the transition condition C2 and the transition condition C4 are satisfied, the timer 422 has reached a predetermined expiration time while neither the transmission nor reception of an NM frame is taking place, so the sleep function and wake-up function of the transceiver 4 are enabled. That is, when the controller 3 transitions from the network mode A101 through the prepared bus sleep mode A102 to the bus sleep mode A103, the sleep function and wake-up function of the transceiver 4 are enabled.

When the controller 3 determines that a transition condition C5 is satisfied in the bus sleep mode A103, the controller 3 transitions to the sleep mode A104. The transition condition C5 is satisfied when a processing required for stopping partial functions, which were in operation states in the network mode A101, is completed. An example of the process required to stop the partial function is as described above. The transition condition C5 includes a condition that a predetermined function of the transceiver 4 (for example, a transmitting function of various signals, data, and the like to another transceiver 4) has stopped by the sleep function.

When the controller 3 determines that a transition condition C6 is satisfied in the sleep mode A104, the controller 3 enters the bus sleep mode A103. The transition condition C6 is a condition that a returning factor from the power saving mode to the normal mode (hereinafter, referred to as a returning factor) occurs. The returning factor also includes receiving a wake-up request from the adjacent ECU. The returning factor may be different for each ECU. Examples of the returning factor includes that the vehicle door is unlocked and that the TCU (i.e., Telematics Control Unit) installed in the vehicle receives a specified signal from outside the vehicle (for example, an operating signal for vehicle equipment such as the engine and the air conditioner).

When the controller 3 determines that a transition condition C7 is satisfied in the bus sleep mode A103, the controller 3 enters the network mode A101. The transition condition C7 is satisfied when a process required for switching to the network mode A101 corresponding to the returning factor is completed. Examples of the processing required to start operation include processing to enable the setting values of the controller 3 related to transmission to the transceiver 4, and processing to start the operating clocks used in creating various signals and data to be transmitted to the adjacent ECU and transmitting them to the transceiver 4. The transition condition C7 includes that the predetermined function of the transceiver 4 (for example, a function for transmitting various signals and data to another transceiver 4) is restarted by the wake-up function.

### 1-3. Operation and Effects

According to the embodiment described above in detail, the following operations and effects can be obtained.
(1a) After the controller 3 transitions from the bus sleep mode A103 to the network mode A101, the sleep function and wake-up function of the transceiver 4 have been disabled. When the controller 3 transitions from the network mode A101 through the prepared bus sleep mode A102 to the bus sleep mode A103, the sleep function and wake-up function of the transceiver 4 are enabled.

That is, the sleep function and wake-up function of the transceiver 4 are disabled until the controller 3 transitions from the network mode A101 through the prepared bus sleep mode A102 to the bus sleep mode A103. Therefore, it is possible to prevent the sleep function and wake-up function of the transceiver 4 from unintentionally preventing the controller 3 from transitioning from the network mode A101 through the prepared bus sleep mode A102 to the bus sleep mode A103.
(1b) The transceiver 4 autonomously enables and disables the sleep function and wake-up function of the transceiver 4 depending on whether the communication data passing through the transceiver 4 is the NM frame. In other words, the controller 3 does not perform any specific processing aimed at enabling and disabling the sleep and wake-up functions of the transceiver 4.

According to such a configuration, it is possible to reduce the load on the controller 3 when enabling and disabling the sleep function and wake-up function of the transceiver 4.

### 1-4. Correspondence Between Terms

In the above embodiment, the NM frame corresponds to an example of control data, the specified expiration time corresponds to an example of a specified time, the network mode A101 corresponds to an example of a first state, the prepared bus sleep mode A102 corresponds to an example of a second state, and the bus sleep mode A103 corresponds to an example of a third state.

### 2. Second Embodiment

### 2-1. Configuration

In the second embodiment, the basic configuration of control system 100 is similar to that of the first embodiment. In the following description, configurations of the control system 100 according to the second embodiment, which are different from those of the first embodiment, will be selectively described. In the second embodiment, configurations that are assigned the same reference symbols as in the first embodiment and are not described below may be understood to have the same or equivalent configurations as in the first embodiment.

### 2-2. Process

### 2-2-1. Sleep Handshake State

The transceiver 4 in the second embodiment switches between two of multiple states further including a sleep handshake state. The transceiver 4 switches between two states out of the normal state, the sleep state, and the sleep handshake state, in accordance with a predetermined protocol (for example, TC 10 described above).

The sleep handshake state is passed during the transition from the normal state to the sleep state. In the sleep handshake state, the transceiver 4 performs the handshake as follows. The handshake is a process of notifying the adjacent ECU of a switch to the sleep state and receiving a response to the notification. After completing the handshake, the transceiver 4 stops the predetermined functions of the transceiver 4 and enters the sleep state. When the handshake has not been completed within a predetermined period (for example, within 16 milliseconds), the transceiver 4 determines that the handshake has failed and enters the normal state.

The sleep function in the second embodiment is a function for the transceiver 4 to switch from the normal state to the sleep state via the sleep handshake state in response to a request from the controller 3.

The sleep function in the second embodiment includes, as a process related to handshake, notifying adjacent ECU of a switch to the sleep state. When the transceiver 4 executes the sleep function, the transceiver 4 transmits a signal (hereinafter referred to as a sleep signal) to an adjacent ECU informing execution of the sleep function. Under a condition that a signal (hereinafter referred to as a sleep response) in response to the sleep signal is received from the adjacent ECU, the transceiver stops the predetermined function of itself. The transceiver 4 provides notification of the switch to the sleep state by transmitting the sleep signal.

In the second embodiment, the sleep function is also executed when the transceiver 4 receives the sleep signal from the adjacent ECU. In this case, the transceiver 4 notifies the controller 3 of the local ECU of having received the sleep signal, transmits the sleep response to the adjacent ECU, and then stops the own predetermined functions.

When the transceiver 4 transmits or receives the sleep signal, the transceiver 4 enters the sleep handshake state from the normal state. Then, the transceiver 4 receives or transmits the sleep response, and executes processing to stop the predetermined functions of the transceiver 4. After completing the processing, the transceiver 4 enters the sleep state from the sleep handshake state.

The transceiver 4 in the second embodiment enters the sleep handshake state based on a request from the controller 3 as well as on whether the detection module 42 detects the NM frame.

### 2-2-2. Transceiver State Transition

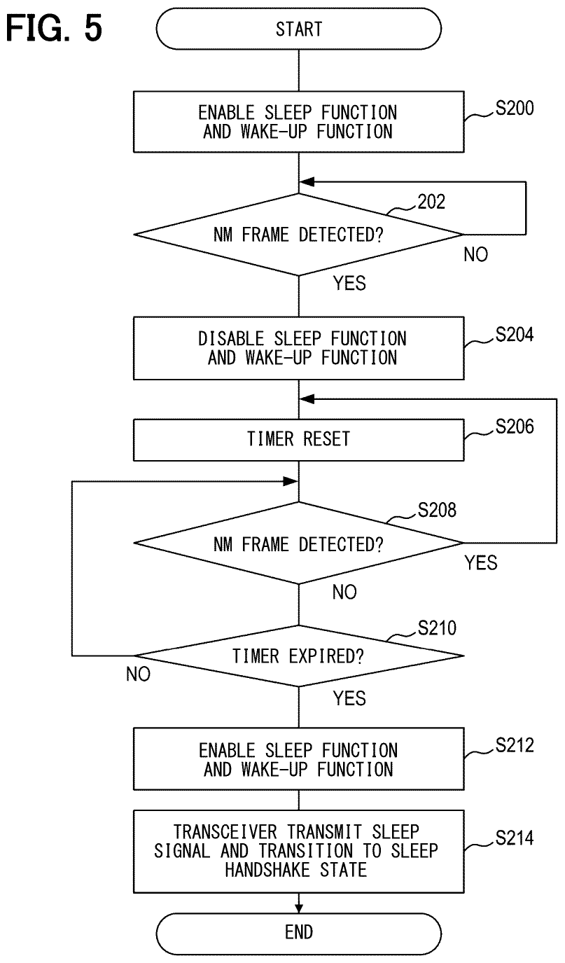

The process of transitioning to the sleep handshake state based on the presence or absence of detection of the NM frame is executed by the transceiver 4 according to the second embodiment, and will be described with reference to the flowchart of FIG. 5.

The controller 425 in the detection module 42 of the transceiver 4 of the second embodiment starts the process shown in FIG. 5 when the transceiver 4 transitions from the sleep state to the normal state. The controller 425 also starts the process shown in FIG. 5 when the transceiver 4 is reset and when the ignition switch of the vehicle is turned from off to on.

The process executed in S200, S202, S204, S206, and S208 in FIG. 5 are similar to the process executed in S100, S102, S104, S106, and S108 in FIG. 3 (that is, the processes according to the first embodiment), respectively.

First, in S200, the controller 425 enables the sleep function and the wake-up function through the setting unit 421. Next, in S202, the controller 425 determines whether the detection unit 423 has detected the NM frame.

When the controller 425 determines that the NM frame has not been detected (S202: NO), the controller 425 repeats the determination as to whether the NM frame has been detected until it determines that the NM frame has been detected (S202).

On the other hand, when the controller 425 determines in S202 that the NM frame has been detected (S202: YES), the process proceeds to S204, where the controller 425 disables the sleep function and the wake-up function via the setting unit 421.

Next, in S206, the controller 425 resets and starts the count of the timer 422. Next, in S208, the controller 425 determines whether the detection unit 423 has detected the NM frame.

When the controller 425 determines in S208 that the NM frame has been detected (S208: YES), the process returns to S206. Thereby, the count of timer 422 is reset when the NM frame is detected.

On the other hand, when the controller 425 determines in S208 that the NM frame has not been detected (S208: NO), the process proceeds to S210, where it determines whether the timer 422 has reached a predetermined expiration time. The predetermined expiration time is the sum of the first predetermined period in the transition condition C2 described above, and the second predetermined period in the transition condition C4 described above. Alternatively, the predetermined expiration time is a third predetermined period in transition condition C4 described above. The predetermined expiration time may be equal to or greater than the sum of the first predetermined period and the second predetermined period.

When the controller 425 determines in S210 that the timer 422 has not reached the predetermined expiration time (S210: NO), the process returns to S208. Thereby, it is determined whether the NM frame has been detected again.

On the other hand, when the controller 425 determines in S210 that the timer 422 has reached the predetermined expiration time (S210: YES), the process proceeds to S212and enables the sleep function and the wake-up function via the setting unit 421.

Next, in S214, the controller 425 executes a process for causing the transceiver 4 to transition to the sleep handshake state. By executing this process, the transceiver 4 transmits the sleep signal to the adjacent ECU and transitions to the sleep handshake state. Thereafter, the controller 425 ends the process shown in FIG. 5.

In this way, the transceiver 4 disables the sleep and wake-up functions when it detects the NM frame. When the transceiver 4 does not detect the NM frame for a predetermined period, it enables the sleep function and wake-up function, transmits the sleep signal to adjacent ECUs, and then enter the sleep handshake state.

At the time when the transceiver 4 transmits the sleep signal, the controller 3 has transitioned to the bus sleep mode A103. Therefore, the transition of the controller 3 from the prepared bus sleep mode A102 to the bus sleep mode A103 is not prevented by the transmission of the sleep signal by the transceiver 4.

### 2-3. Effects

According to the second embodiment described above in detail, the same effects as those of the first embodiment can be obtained. In addition, according to the second embodiment, the state of the transceiver 4 autonomously transitions from the normal state to the sleep state via the sleep handshake state without receiving a request from the controller 3. Therefore, when the ECU transitions to the power saving mode, it is possible to reduce the load on the controller 3. Furthermore, while complying with a standard (for example, TC10) that requires the handshake when the ECU transitions to the power saving mode, the ECU itself can transition to the power saving mode in synchronization with the adjacent ECU.

### 3. Other Embodiments

While the embodiments of the present disclosure have been described above, the present disclosure is not limited to the above embodiment and can be variously modified.
(3a) In the above embodiment, the transceiver 4 disables the sleep function and the wake-up function upon detecting the NM frame. When the transceiver 4 does not detect the NM frame for a predetermined period, it enables the sleep function and the wake-up function. However, it is not necessary to enable and disable the sleep function and wake-up function of the transceiver 4 in all of the ECUs in the in-vehicle network. In other words, the transceivers 4 mounted on some of the ECUs among the multiple ECUs in the in-vehicle network do not need to disable the sleep function and wake-up function when they detect the NM frame. The transceiver 4 mounted on some of the ECUs among the multiple ECUs in the in-vehicle network may not enable the sleep function and the wake-up function when they do not detect the NM frame for a predetermined period.

For example, when the in-vehicle network has a PN (Partial Networking) function that selectively enables and disables the sleep function and wake-up function of the transceivers 4 on the network, it is not necessary to enable and disable the sleep function and wake-up function of some transceivers 4.
(3b) Multiple functions of one element in the described above embodiment may be implemented by multiple elements, or one function of one element may be implemented by multiple elements. Further, multiple functions of multiple elements may be implemented by one element, or one function implemented by multiple elements may be implemented by one element. Part of the configuration of the above embodiment may be omitted. At least a part of the configuration in one embodiment may be added to or substituted for the configuration of another embodiment.
(3c) The present disclosure can be implemented in various forms in addition to the transceiver and the control system described above. For example, the present disclosure can be implemented in the form of the control system that includes the transceiver as a component, a computer program for causing a computer to function as the transceiver, a non-transient physical recording medium such as a semiconductor memory on which the computer program is recorded, a control method, and the like.

What is claimed is:

1. A transceiver mounted in an electronic control unit for a vehicle and configured to perform communication with a communication device, the transceiver comprising:
a detection unit configured to detect control data used at least for controlling a state transition of the electronic control unit, the control data being transmitted from the communication device through the communication; and
a setting unit configured to enable and disable a sleep function and a wake-up function of the transceiver,
wherein
the state transition is a transition between a plurality of states including at least a first state, a second state, and a third state,
the electronic control unit transitions between the plurality of states, and operates in any one of the plurality of states,
in a case where a state in which no communication is performed continues after transition to the first state, the electronic control unit transitions to the second state or the third state in sequence according to a continuation period of the state in which no communication is performed,
in the third state, a process is executed to stop a part of a function operating in the first state,
in the second state, in a case where the communication occurs between the transceiver and the communication device by the sleep function or the wake-up function of the transceiver, the second state transitions to the first state, and
the setting unit is configured to enable and disable the sleep function and the wake-up function based on whether the control data has been detected by the detection unit.

2. The transceiver according to claim 1, wherein
the setting unit is configured to disable the sleep function and the wake-up function on a condition that the detection unit has detected the control data.

3. The transceiver according to claim 2, wherein
the electronic control unit is configured to transition to the third state in a case where the state in which no communication is performed continues for a predetermined period after the electronic control unit transitions to the first state, and
the setting unit is configured to enable the sleep function and the wake-up function on condition that the detection unit has not detected the control data for the predetermined period.

4. The transceiver according to claim 2, wherein
the setting unit is configured to transmit, on condition that the detection unit has not detected the control data for a predetermined period, a sleep signal notifying the communication device that a transceiver function is partially stopped by the sleep function, to the communication device.

5. The transceiver according to claim 4, wherein
the sleep function partially stops the transceiver function after receiving a response to the sleep signal from the communication device.

6. A control system comprising:
a plurality of electronic control units including at least one transceiver,
wherein
the plurality of electronic control units are configured to function as a node of an in-vehicle network,
each of the plurality of electronic control units is configured to communicate with an adjacent one of the plurality of electronic control units within the in-vehicle network, and
the adjacent one of the plurality of electronic control units corresponds to a communication device,
the transceiver is mounted in at least one of the plurality of electronic control units for a vehicle and configured to perform communication with the communication device,
the transceiver includes:
a detection unit configured to detect control data used at least for controlling a state transition of the electronic control unit, the control data being transmitted from the communication device through the communication; and
a setting unit configured to enable and disable a sleep function and a wake-up function of the transceiver,
the state transition is a transition between a plurality of states including at least a first state, a second state, and a third state,
the electronic control unit transitions between the plurality of states, and operates in any one of the plurality of states,
in a case where a state in which no communication is performed continues after transition to the first state, at least one of the plurality of electronic control units transitions to the second state or the third state in sequence according to a continuation period of the state in which no communication is performed,
in the third state, a process is executed to stop a part of a function operating in the first state,
in the second state, in a case where the communication occurs between the transceiver and the communication device by the sleep function or the wake-up function of the transceiver, the second state transitions to the first state, and
the setting unit is configured to enable and disable the sleep function and the wake-up function based on whether the control data has been detected by the detection unit.
